(19) United States
(12) Patent Application Publication
(10) Pub. No.: US 2026/0369888 A1
(43) Pub. Date: Nov. 19, 2026

(54) ECONOMICAL HIGH-POWER BROADBAND CIRCULARLY POLARIZED FM BROADCAST PANEL ANTENNA

(71) Applicant: DIELECTRIC, LLC, Raymond, ME (US)

(72) Inventors: Mersedeh NAJISHABAHANG, Raymond, ME (US); Casey GOVONI, Raymond, ME (US)

(21) Appl. No.: 19/679,167

(22) Filed: May 15, 2026

Related U.S. Application Data
(60) Provisional application No. 63/806,258, filed on May 15, 2025.

(51) Int. Cl. H01Q 9/16; H01P 1/00; H01Q 15/24; H01Q 19/10

(52) U.S. Cl. CPC H01Q 9/16; H01Q 15/24; H01Q 19/10; H01P 1/00

(57) ABSTRACT

A broadband circularly-polarized combiner-capable (CPC) FM broadcast antenna panel uses a single balun large, widened dipoles, multi-stage matching, and/or a parasitic ring to provide broadband high power operation radiator with a reduced parts count. The horizontal to vertical polarization ratio (H/V) can be stabilized across the FM band by using a combination of panel rotation and phase shift in a multilayer array.

### TECHNICAL FIELD

This disclosure relates to circularly polarized frequency modulated (FM) band panel broadcast antennas.

### BACKGROUND

Historically, broadband circularly polarized multi-station FM panel broadcast antennas have been limited to crossed dipole or quad dipole designs with two or more inputs per panel. These designs require a significant number of radiator parts and elaborate external feed systems with many cables, power dividers and/or 90-degree hybrids. In all of the current designs, the number of stations and the maximum total power that the master FM antenna can accommodate is usually limited by the size of the input balun of each radiator.

U.S. Pat. No. 4,062,019 (Woodward and Siukola), “Low cost linear/circularly polarized antenna,” granted Dec. 6, 1977, describes a linear/circularly polarized antenna system is provided by four conductive elements. The conductive elements are joined in pairs at their ends with the joined ends spaced by a conductive support member from a flat reflector. The lengths of the conductive elements of each dipole element are changed from being equal lengths of approximately a quarter operating frequency wavelength to one slightly longer and the other slightly less than a quarter wavelength to selectively change operation from that of a linearly polarized antenna to that of a circularly polarized antenna.

For general background, see Constantine A. Balanis, “Antenna Theory Analysis and Design,” Harper & Row Publishers, 1982. See also John L. Schadler “ATSC 3.0 Ready-Designing Antennas for Higher Power OFDM PAPR,” NAB BEIT, 2018.

### SUMMARY

A broadband circularly-polarized combiner-capable (CPC) FM broadcast antenna panel is created with fewer parts in each radiator and a single input to each panel. The single input considerably reduces the amount of required external feed system which in turn reduces cost and improves reliability. The design uses a single large balun tube that allows high power operation. No feed straps are required. By lowering the Q of the dipole by increasing the diameter as well as adding two more stages to the matching network circuit, the bandwidth of the traditional DCPJ FM broadcast panel antenna can be increased to full band operation. The H/V ratio can be stabilized across the FM band by using a combination of panel rotation and phase shift in a multilayer array.

### BRIEF DESCRIPTION OF THE FIGURES

FIGS. 1A-1C show top and isometric views of the three traditional dipole designs used in FM broadcast panels. FIG. 1A shows a quad dipole panel. FIG. 1B shows a horizontal/vertical crossed dipole pair panel. FIG. 1C shows a +/−45 degree crossed dipole pair panel.

FIG. 2A is an isometric view of a traditional single layer panel array layout for a quad dipole configuration.

FIG. 2B is a schematic of a traditional feed system layout for a quad dipole configuration.

FIG. 3A is an isometric view of a traditional single layer panel array layout for a horizontal/vertical dipole or a +/−45-degree dipole configuration.

FIG. 3B is a schematic of a traditional feed system for a horizontal/vertical dipole or a +/−45-degree dipole configuration.

FIG. 4 is graph of input impedance vs. length of a 0.0042λ diameter dipole.

FIG. 5 is a graph of feed point phase of Zin vs. length of a 0.0042λ diameter dipole.

FIG. 6A is an isometric view of a single-input, circularly-polarized DCPJ FM broadcast panel antenna mounted on a transmission tower.

FIG. 6B is an isometric view of a DCPJ panel.

FIG. 7A is an isometric view of a single layer DCPJ panel array.

FIG. 7B is a schematic of a feed system layout for a DCPJ panel configuration.

FIG. 8 is a graph comparing input reactance vs. length of a 0.0042λ diameter dipole compared to a 0.0125λ dipole.

FIG. 9 is a graph of feed point phase of Zin vs. length of a 0.0125λ diameter dipole.

FIG. 10 is a schematic of a matching network.

FIG. 11 is a schematic of a traditional matching network of a DCPJ FM broadcast panel.

FIG. 12 is a graph of VSWR vs. Frequency of a traditional DCPJ panel antenna matched at 98 MHz using a transformer in the balun.

FIG. 13A is an isometric view of a circularly-polarized combiner-capable (CPC) antenna panel.

FIG. 13B is a matching network for the panel of FIG. 13A.

FIG. 14 is a graph of VSWR vs frequency of the CPC design implemented with 3″ diameter dipole arms.

FIG. 15A is an isometric view of a CPC panel with a short circuit stub inside a dipole arm and connected to the feed point.

FIG. 15B is a schematic of the matching network for the CPC design of FIG. 15A.

FIG. 16 is a graph of VSWR vs. frequency of the CPC with a short circuit stub in one of the dipole arms.

FIG. 17A is an isometric view of a CPC with a floating parasitic ring above the dipoles.

FIG. 17B is a schematic of the matching network of a CPC with short circuit stub and parasitic ring.

FIG. 18 is a graph of VSWR vs. frequency of the CPC with the short circuit stub in one of the dipole arms and the parasitic ring.

FIG. 19 is an isometric view of a power limiting area of a traditional broadband master FM panel antenna.

FIG. 20 illustrates an electric field analysis of a CPC panel antenna.

FIG. 21A shows a top view of a CPC antenna.

FIG. 21B shows graphs of horizontal and vertical polarization of the CPC FM panel antenna at three frequencies across the band.

FIG. 22A is a schematic for phase shifting to achieve a stabilized horizontal and vertical polarization ratio of the CPC FM panel antenna across the band of a two-layer array using bay rotation.

FIG. 22B should graphs of horizontal and vertical polarization of the two-layer array of FIG. 22A.

### DETAILED DESCRIPTION

### Introduction

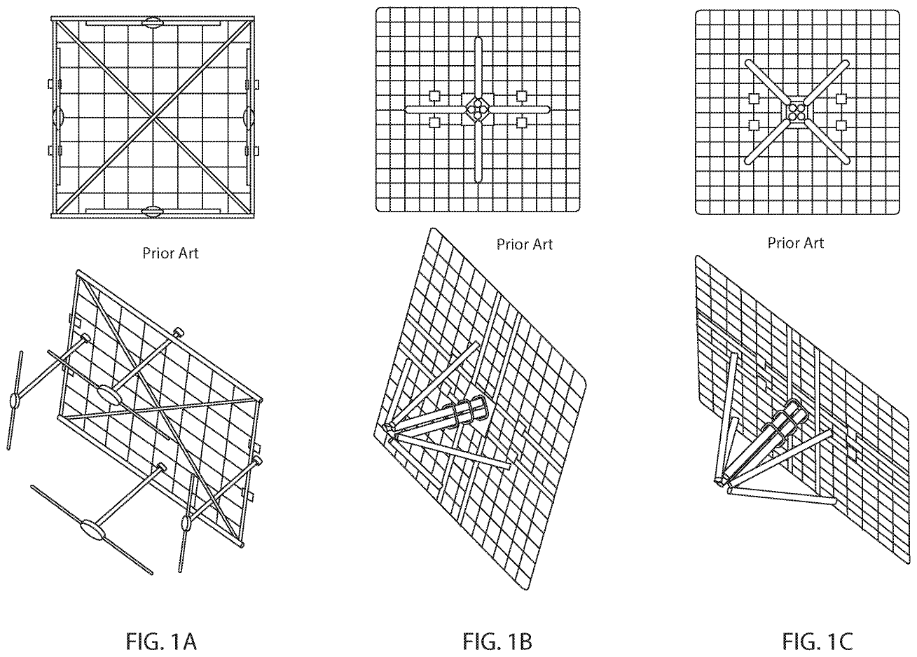

Broadband circularly polarized FM broadcast panel antennas on the market today are generally variations of the three basic dipole designs illustrated in FIG. 1A—quad dipole; FIG. 1B—horizontal/vertical crossed dipole pair, or FIG. 1C—+/−45 degree crossed dipole pair. In all cases, these designs have a panel and either two or four inputs per panel or a hybrid attached to the back of each panel converting the inputs into a single feed. Hybrids simplify the external feed system but add both cost and complexity to the panel.

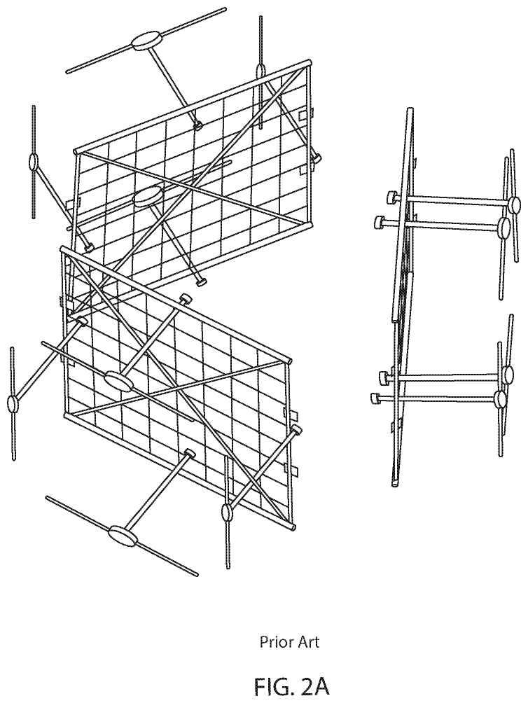

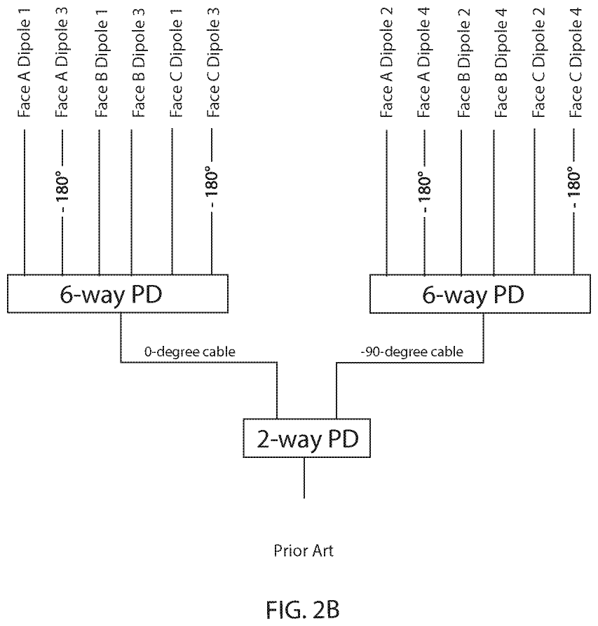

For simplicity of comparison, assume a panel array of a single layer of three panels around without the use of hybrids attached to the panel inputs, as shown in FIG. 2A. The feed system for the quad design array would typically consist of a two-way power divider feeding two six-way power dividers feeding twelve cables as shown in FIG. 2B.

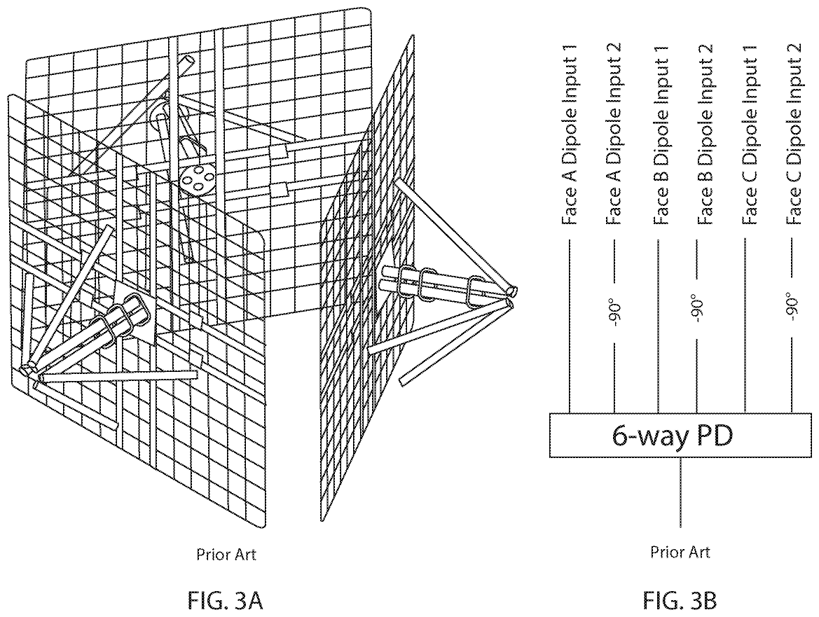

For the same simple single layer array case, both the horizontal/vertical crossed dipole pair (shown in FIG. 3A) and the +/−45 degree crossed dipole pair would typically utilize a single six-way power divider feeding six cables as shown in FIG. 3B. Note in FIG. 3B that the horizontal/vertical or the +/−45-degree dipole pairs require only half of the external feed system compared to the quad dipole design, thus reducing the number of cables and connections.

### Impedance of a Dipole

The input impedance of a dipole can be calculated using Formulas 1-5 of Appendix A. Formula 1 expresses the dipole input impedance Zᵢₙ in terms of input resistance Rᵢₙ and input reactance Xᵢₙ. Formulas 2 and 3 show the calculation of Rᵢₙ and Xᵢₙ, respectively.

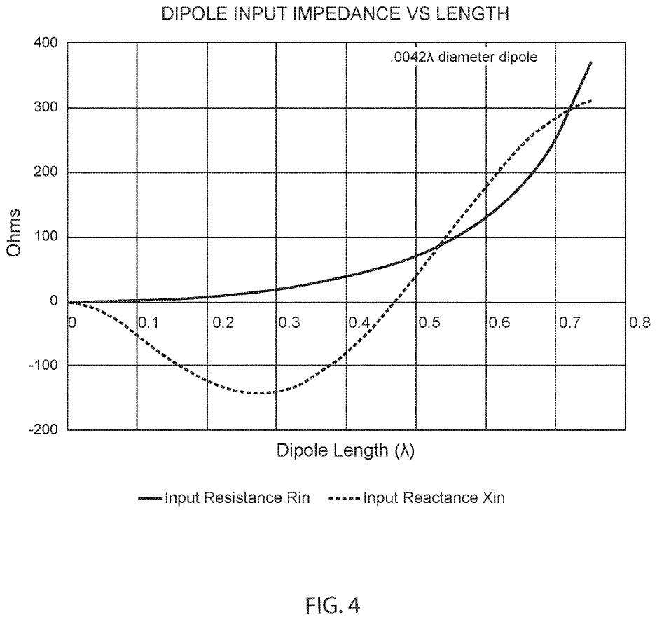

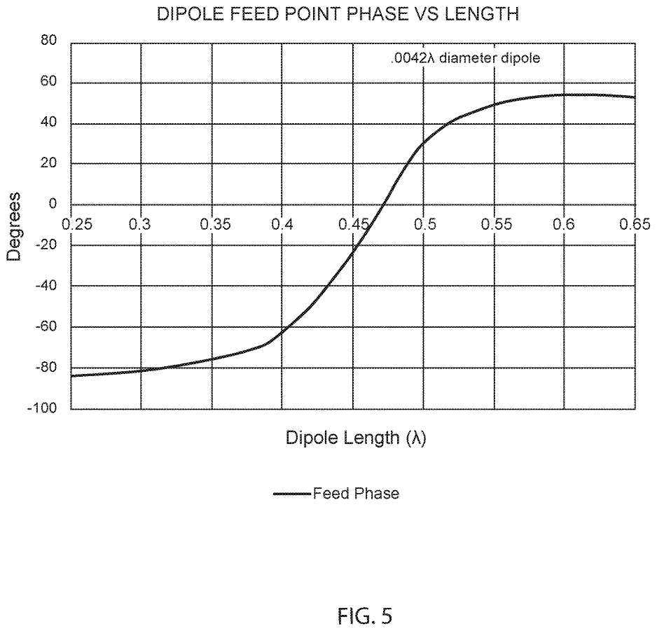

To understand how the radiated amplitude and phase of a dipole changes versus its length, the dipoles input impedance can be plotted using equations 2 and 3 as shown in FIG. 4. In FIG. 4, the input impedance is the ratio of voltage to current at the feed point location which is directly related to the feed point phase. The resonance of a center fed dipole is where the reactance is zero and the dipole impedance is purely real. This occurs at a length that is slightly less than half of a wavelength. At this location, the feed point phase is zero. Using the real and imaginary parts of Zin, (Rin and Xin), the feed point phase can be calculated and plotted as shown in FIG. 5.

In FIG. 5, it is apparent that a 90-degree phase differential can be obtained between two dipoles with a small length difference between them. This occurs between approximately 0.4 and 0.5 wavelengths.

### Single Input Circularly Polarized Panel Antenna

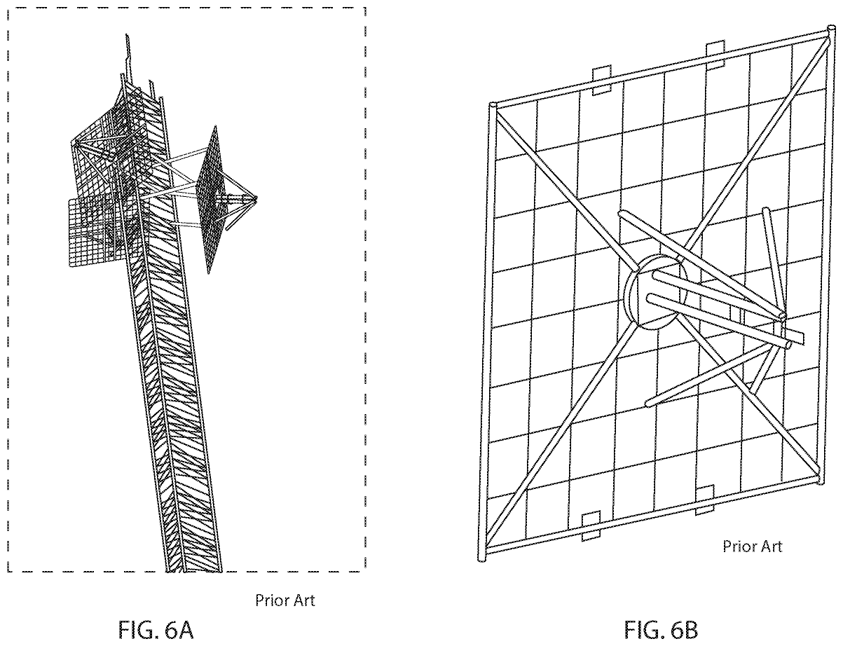

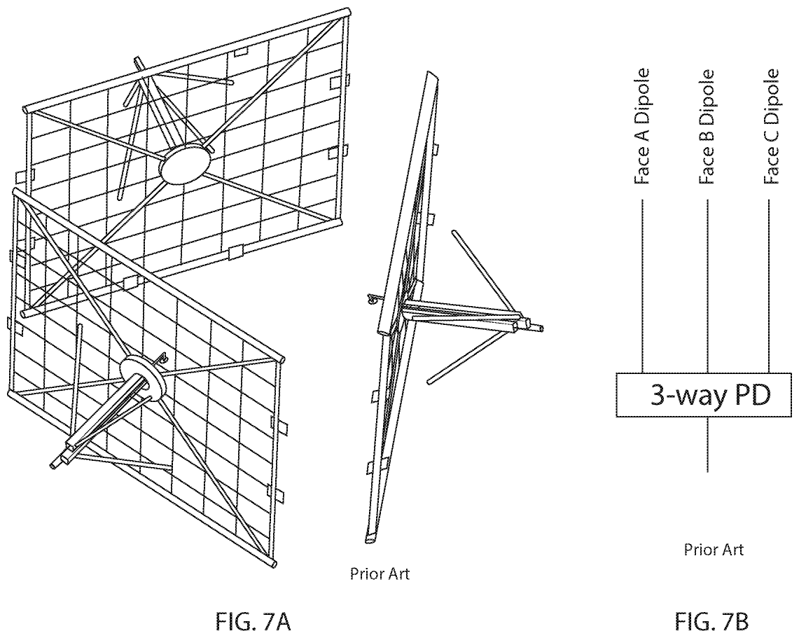

The concept of a single input circularly polarized FM broadcast panel antenna without the use of a hybrid was first demonstrated in Oakley Woodward and Matti Siukola's U.S. Pat. No. 4,062,019 in 1977. The product that was born from the RCA's inventor's innovation came to be known as the DCPJ and is still a popular product today. The panel's premise is based on creating the circularly polarized signal by feeding a pair of dipoles each having two arms of differential length. Since the balun feed creates a 180-degree phase shift and the differential dipole lengths create a 90-degree offset as shown in FIG. 5, the four dipoles are then fed by phases of 0, 90, 180, and 270 degrees respectively, forming the circularly polarized signal. This technique simplifies the design by eliminating the need to have two inputs, four balun tubes, or possibly a hybrid. The single input design requires only half the number of necessary cables in the external feed system compared to the horizontal/vertical or +/−45-degree dipole pair designs and only one quarter of the cables compared to the quad dipole design. FIG. 6A shows a DCPJ FM broadcast panel antenna array mounted on a tower. FIG. 6B shows a single DCPJ panel. FIG. 7A shows a single layer panel array. FIG. 7B shows a and feed system layout for the DCPJ panel configuration of FIG. 7A. Compare the feed system layout of FIG. 7B to those of FIGS. 2B and 3B. The DCPJ provides an economical solution to expensive cavity backed radiator designs, but due to its limited impedance bandwidth, it has been confined to single channel operation.

### Increasing Bandwidth

A number of techniques are available to improve upon 3 MHz bandwidth of the traditional DCPJ to create comparable arrays with 20 MHz FM bandwidth. The dipoles sizes and angles are adjustable and scalable depending on the specific frequency to achieve 20 percent bandwidth at any part of the spectrum.

### Increasing Dipole Diameter

A first technique is to increase dipole diameter. The Q or quality factor is defined by the ratio of the reactance to the resistance and is inversely proportional to bandwidth, as given in Formula 6 of Appendix A.

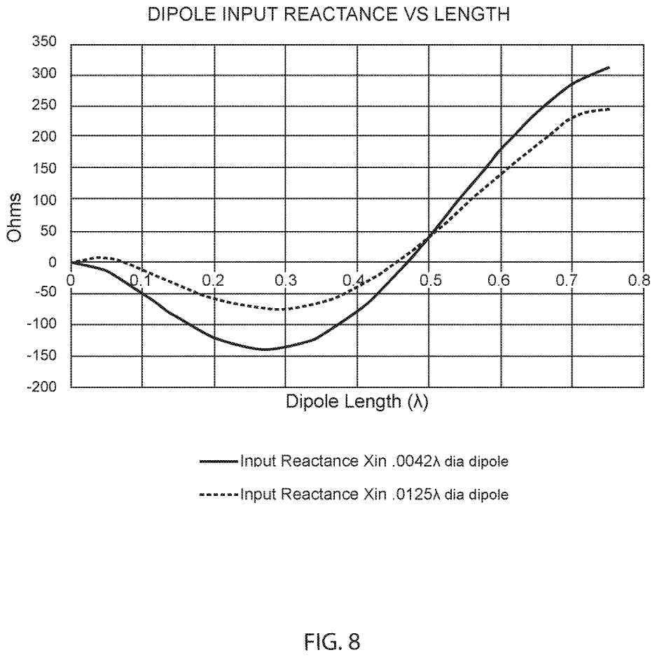

From equations 2 and 3, the dipole radius (a) only shows up in the reactance (X_{IN}). This leads to thicker dipoles having broader bandwidth. This is because they exhibit a smaller change in reactance with frequency. Historically, the DCPJ dipole utilized 1″ diameter tubes as the radiating elements. This corresponds to 0.0042λ at the center of the FM band and the resulting reactance was shown in FIG. 4. Using equation 3, FIG. 8 shows the comparison, at FM frequencies, in reactance between a 1″ (0.0042λ) and a 3″ (0.0125λ) diameter dipole.

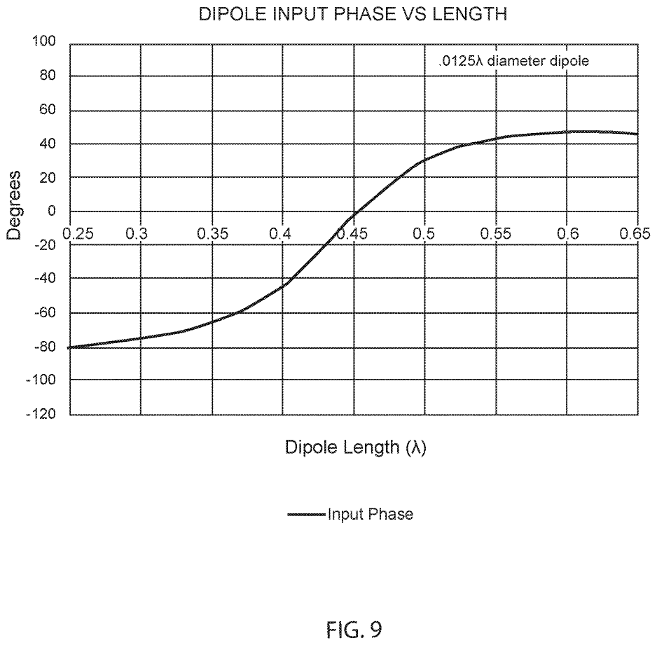

The increase in diameter shows the rate of change of the reactance is significantly reduced which translates to a broader bandwidth. This affects the phase change vs. length differential, which is necessary to produce circular polarization, but with this diameter, a 90-degree difference near response is still attainable as shown in FIG. 9.

### Short Circuit Stub

A short circuit stub when positioned and sized on a transmission line acts as a reactive element that will cancel out the reactive component of a load impedance and effectively broaden the usable bandwidth. Keeping the short circuit stub as close to the load as possible provides the best bandwidth to the match.

### Parasitic Element

Parasitic elements are passive elements that are coupled to a main driven antenna element. They are not fed with power, but they resonate at frequencies slightly different from the driven element. Adding parasitic elements to an antenna such as discs, rods or rings above a dipole can significantly increase its bandwidth by leveraging the combined frequency responses of the driven and the parasitic element. This practice is commonly seen in the use of log periodic antennas designed to operate over a wide band of frequencies.

### Matching Networks

A matching network is used to match the impedance of a source to a load. This is done by using capacitors and inductors which can be either lumped elements or in the case of high-power RF, distributed elements. The addition of more elements in a matching network can allow for a wider range of impedance transformations resulting in broader band operation. The traditional DCPJ panel has only one matching element, a transformer in the balun, designated here as Z_{B} to match the load of the dipole Z_{D}. This limits the usable bandwidth to centering a frequency of interest.

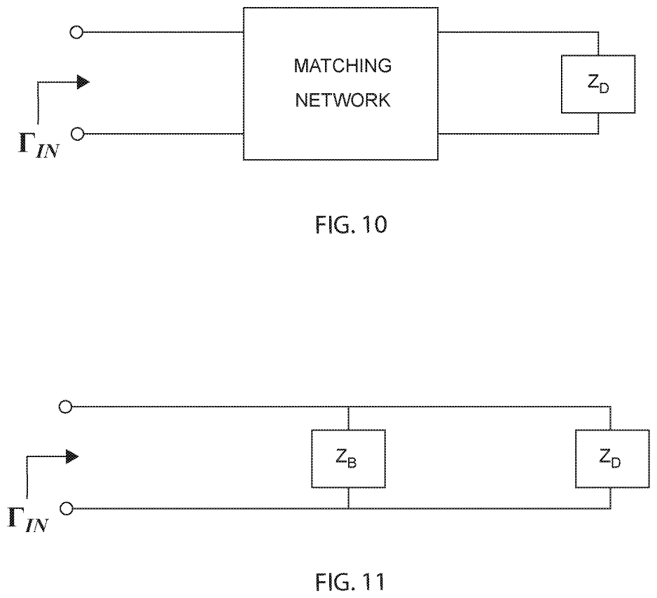

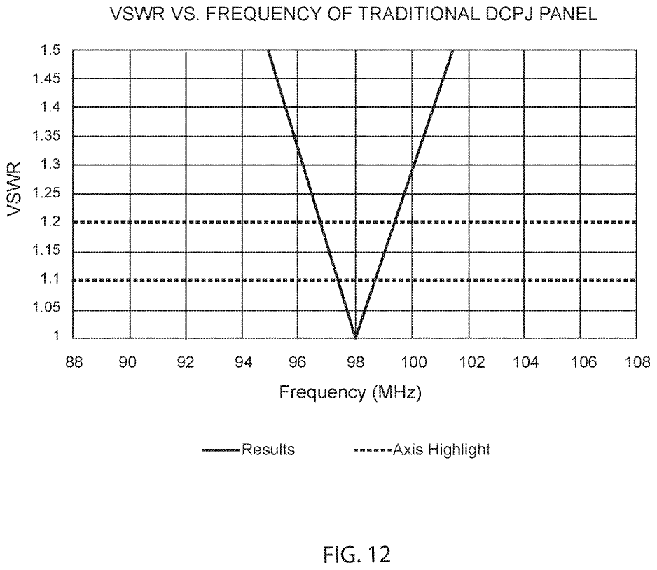

FIG. 10 illustrates a matching network. FIG. 11 illustrates a matching network of a traditional DCPJ FM broadcast panel. The matched impedance at 98 MHz using a transformer in the balun (Z_{B}) on a typical DCPJ panel is shown in FIG. 12. Note the bandwidth that is under a 1.2:1 VSWR is 3 MHz in FIG. 12.

### Circularly-Polarized Combiner-Capable (Cpc) Antenna

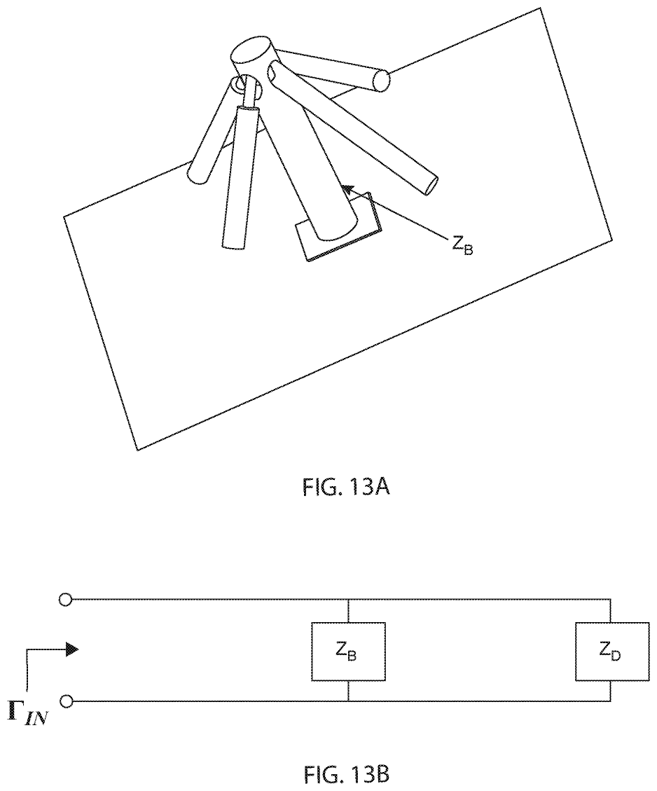

By implementing the methods of increased dipole diameter, short circuit stub, parasitic element, and adjusted matching elements, the operating bandwidth of the CPC can be expanded to provide a full band product. The design starts with increasing the diameter of the dipole from 1″ to 3″. FIG. 13A illustrates the basic design of the new CPC. The balun has been made into a single tube for simplicity and reduction of parts. FIG. 13B shows a layout for its matching network.

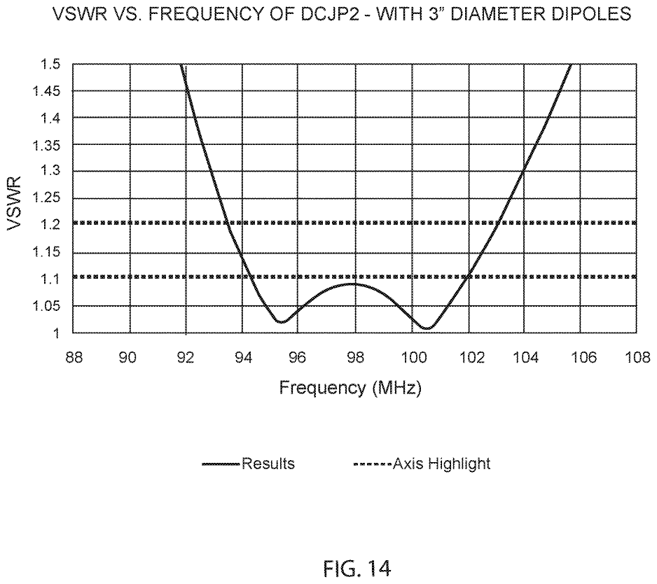

FIG. 14 is a graph of VSWR vs frequency of the balun matched design of the CPC with 3″ diameter dipole arms.

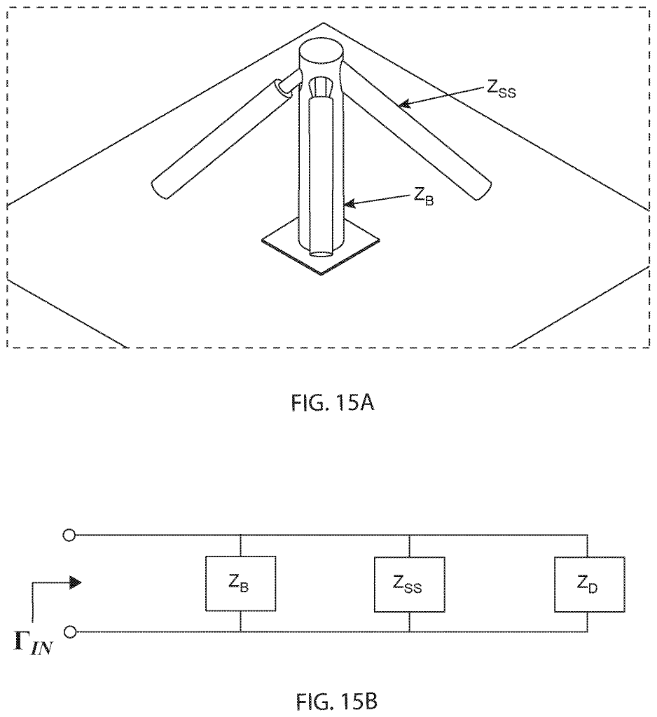

The bandwidth that is under 1.2:1 VSWR has now increased to 9.5 MHz but rises sharply outside of the matched region. Utilizing one of the empty dipole arms, the next step is to add a short circuit stub denoted as Zss from the feed point down through the arm as shown in FIG. 15.

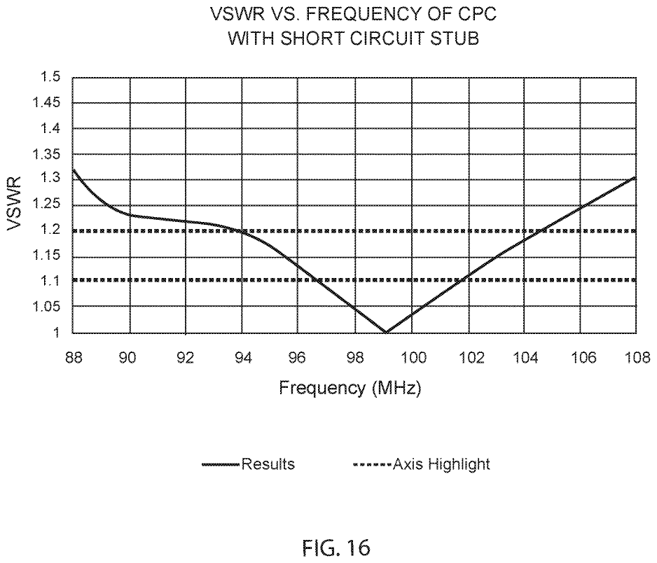

FIG. 15A illustrates adding a short circuit stub inside a dipole arm and connected to the feed point. FIG. 15B shows the matching network layout for the antenna configuration of FIG. 15A. FIG. 16 is a graph of the configuration of FIG. 15A. The bandwidth with the addition of the stub has now increased to 10 MHz under a 1.2:1 VSWR. More importantly, the band edges have flattened out considerably and the design is approaching a full band solution.

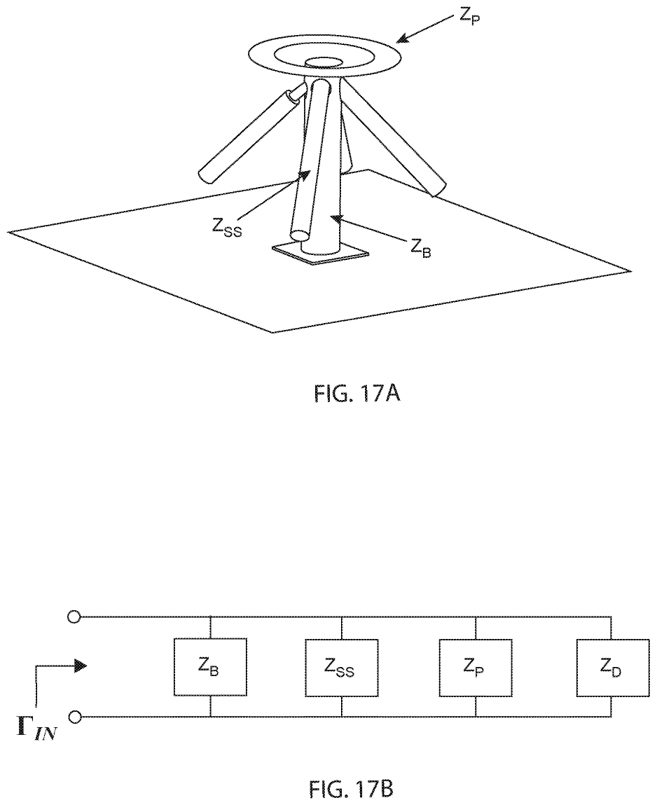

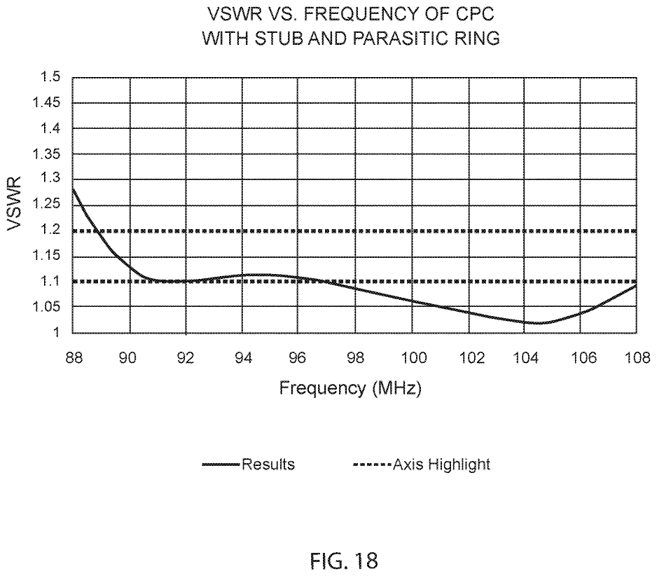

The final step is to add a floating parasitic ring denoted as Zp above the dipoles as shown in FIG. 17A. FIG. 17B shows the matching network layout for the configuration of FIG. 17A. FIG. 18 is a graph of VSWR vs. frequency of the CPC of FIG. 17A, which includes the a short circuit stub in one of the dipole arms and the parasitic ring. The bandwidth with the addition of the stub and the parasitic ring has now increased to 19 MHz under a 1.2:1.

### Power Handling

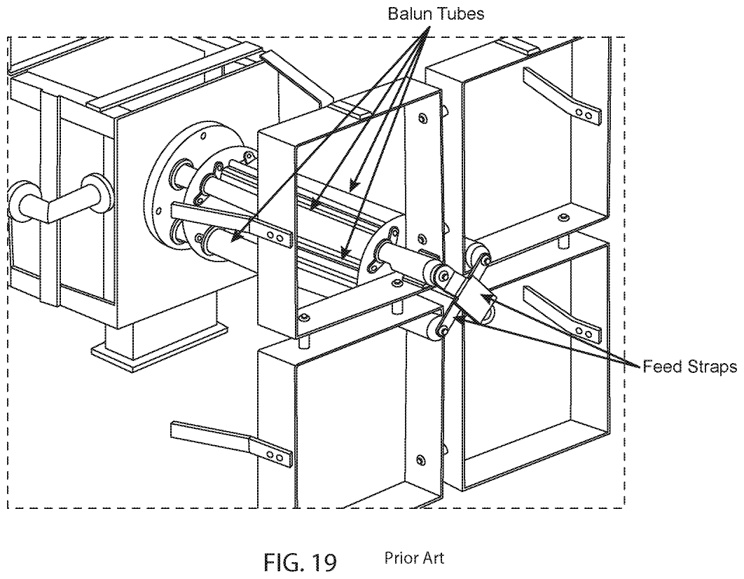

Typically, broadband master FM broadcast antennas are designed to handle high power to accommodate the total required energy of all the stations combined. In many cases, the limiting factor is the balun tube itself or the flat feed strap that is used to jumper the inner conductor in the balun to the other half of each dipole. FIG. 19 shows a typical power limiting area of a broadband master FM panel antenna.

The new CPC utilizes a single balun tube that is 6″ in diameter and does not require any feed straps. See FIGS. 13A, 15A and 17A. This is a vast improvement over existing designs which have multiple smaller size balun tubes and feed straps that are subject to breakdown. Field analysis of a single bay with 10 kW power applied to the input reveals a peak voltage of 4.11 kV/cm. Comparing this value to the E-field breakdown in air (22.8 kV/cm), the voltage safety factor of the CPC is 5.5:1. See John L. Schadler “ATSC 3.0 Ready-Designing Antennas for Higher Power OFDM PAPR”, NAB BEIT, 2018. Note that this translates to over a 30:1 safety factor in the peak power.

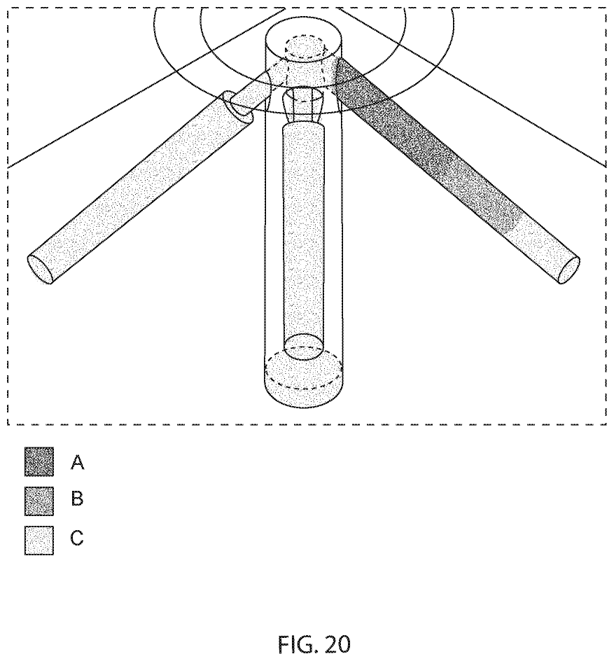

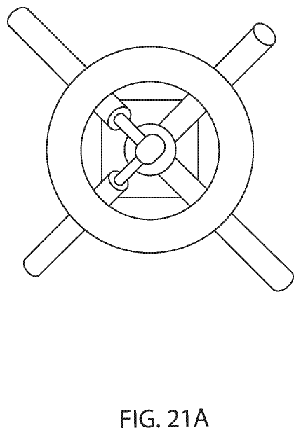

FIG. 20 shows an e-field analysis of the CPC panel antenna. Electric field analysis of the dipoles revealed that field intensity is most concentrated at sharp angles and narrow surfaces. Specifically, the arm featuring the short-circuit stub exhibited the highest field strength, peaking at 4.11 kV/cm. This value highlights the maximum electric field intensity localized at the dipole supporting the stub.

### Azimuth Pattern and H/V Ratio

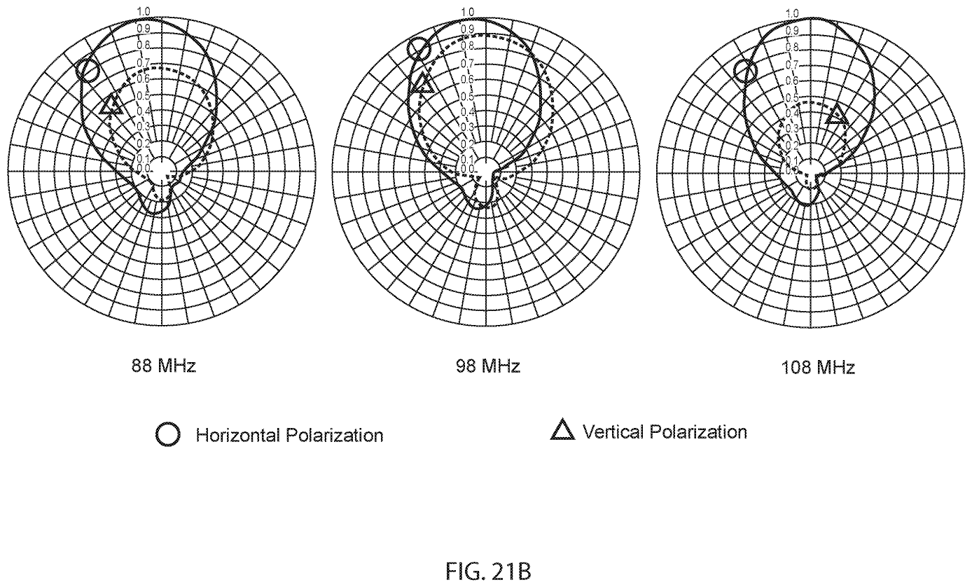

Since the horizontal to vertical polarization ratio (H/V ratio) is a function of the differential dipole length on the CPC as discussed earlier, the ratio will vary with frequency. The H/V ratio on a single panel can be set to near one or equal horizontal and vertical components at the center frequency of 98 MHz. When doing so, the ends of the FM band 88 and 108 MHz have ratios of 0.67 and 0.45 respectively as seen in FIG. 21B, which shows the H/V ratio of the CPC FM panel antenna across the band.

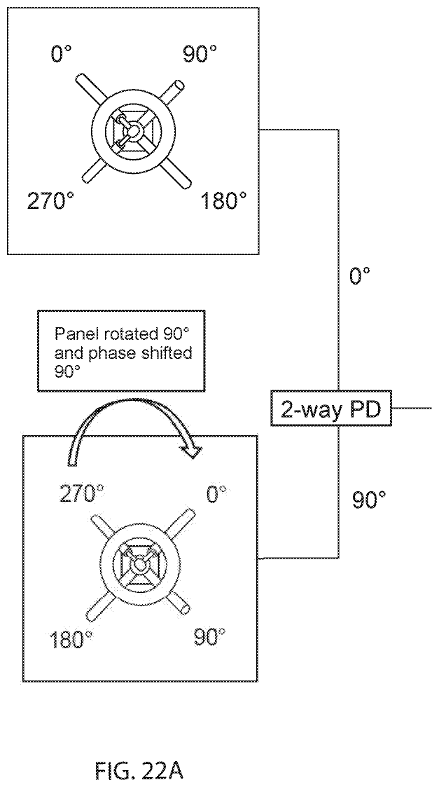

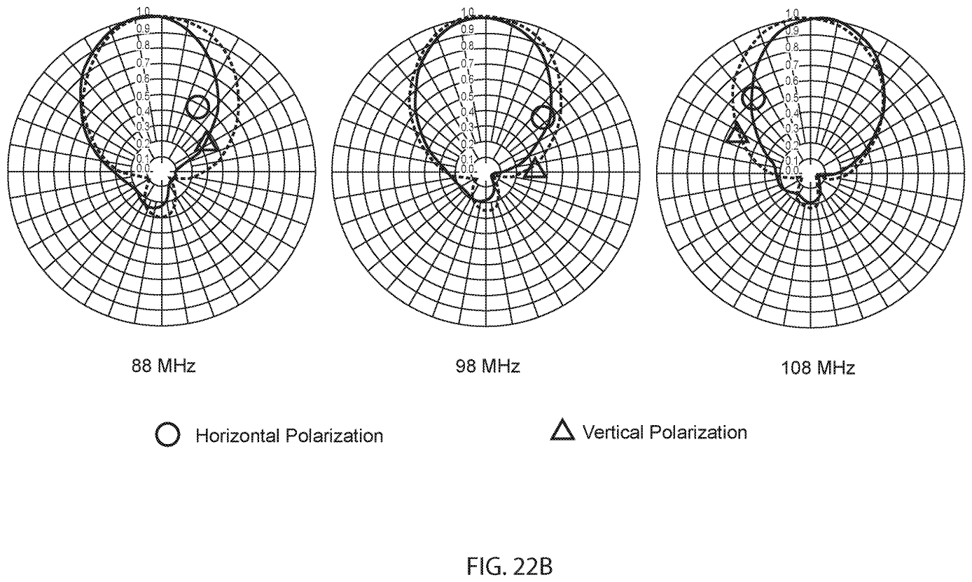

Although not bad, this can be greatly improved to close to a perfect H/V ratio of one across the band. By utilizing the fact that the bays can be rotated to switch the horizontal and vertical components on every other layer in a multilayer system, the mean combined azimuth patterns produce a linear H/V ratio. FIG. 22A illustrates rotating a lower bay whereby the rotating phase (0, 90, 180, 270 degrees) can be brought back into sync by feeding the bay 90 degrees out of phase with respect to the upper bay. The result shown in FIG. 22B is a stabilized H/V ratio of the CPC FM panel antenna across the band of a two-layer array using bay rotation.

Another added benefit of feeding alternating bays 90 degrees out of phase is impedance cancelation. Since the impedance of half the bays will be rotated a quarter wave from the other half, the resulting VSWR will be very low.

### APPENDIX A—FORMULAS

$$FORMULA 1$$

$${Z}_{in} = {R}_{in} + {jX}_{in} Ω \qquad ( 1 )$$

$$FORMULA S 2 and 3$$

$${R}_{in} = \frac{η}{2 π} \{ [ C + ln ( kl ) - {C}_{i} ( kl ) + \frac{1}{2} sin ( kl ) [ {S}_{i} ( 2 kl ) ] + 2 {S}_{i} ( kl ) [ C + ln ( \frac{kl}{2} ) + {C}_{i} ( 2 kl ) - 2 {C}_{i} ( kl ) ] \} / {( sin ( \frac{kl}{2} ) )}^{2} \qquad ( 2 )$$

$${X}_{in} = \frac{η}{4 π} \{ [ 2 {S}_{i} ( kl ) + cos ( kl ) [ 2 {S}_{i} ( kl ) - {S}_{i} ( 2 kl ) ] - sin ( kl ) [ 2 {C}_{i} ( kl ) - {C}_{i} ( 2 kl ) - {C}_{i} ( \frac{2 {ka}^{2}}{l} ) ] \} \qquad ( 3 )$$

$$where$$

$$\begin{matrix}C = 0.5772 ( Euler ’ s constant ) \\ η = \sqrt{\frac{μ}{ε}} ( Intrinsic Impedance ) \\ {S}_{i} ( x ) = {\int }_{0}^{x} \frac{sin y}{y} dy \\ {C}_{i} ( x ) = {\int }_{∞}^{x} \frac{cos y}{y} dy \\ a = Dipole radius \\ k = \frac{2 π}{λ} \\ l = Dipole length\end{matrix}$$

### Formulas 4 and 5

The Sine and Cosine integrals (Sⁱ(x) and Cⁱ(x)) can be approximated using series expansions:

$${S}_{i} ( x ) \approx {\sum }_{n = 1}^{∞} {( - 1 )}^{n - 1} \frac{{( x )}^{2 n - 1}}{( 2 n - 1 ) ( 2 n - 1 ) !} \qquad ( 4 )$$

$${C}_{i} ( x ) \approx C + ln ( x ) + {\sum }_{n = 1}^{∞} \frac{{( - 1 )}^{n} {x}^{2 n}}{( 2 n ) ( 2 n ) !} \qquad ( 5 )$$

$$FORMULA 6$$

$$Q = \frac{\vert {X}_{in} \vert}{\vert {R}_{in} \vert} = \frac{{f}_{c}}{{f}_{2} - {f}_{1}} = \frac{1}{BW} \qquad ( 6 )$$

1. An antenna system, wherein the antenna system is a broadband circularly-polarized combiner-capable FM broadcast antenna system, comprising:
a flat reflective panel;
four dipole arms mounted above the panel via a pillar comprising a single balun;
a parasitic ring mounted above the dipole arms; and
a multi-stage matching network,
wherein:
the pillar is generally orthogonal to the panel;
the dipole arms are attached at one end to the pillar and radiate out from the pillar at angle of 90°±5° increments about pillar; and
the dipolar arms are connected to a single feed via the single balun and the matching network.

2. The antenna system of claim 1, wherein the single balun comprises a balun tube having a diameter between four and seven inches.

3. The antenna system of claim 2, wherein the diameter of the single balun tube is approximately six inches.

4. The antenna system of claim 2, wherein each dipole arm has a diameter between 0.0100 and 0.0150 wavelengths (λ).

5. The antenna system of claim 4, wherein the diameter of each dipolar arm is approximately 0.0125λ.

6. The antenna system of claim 5 wherein, with an applied feed power of 10 KW, exhibits a peak voltage of less than 5 kV/cm.

7. The antenna system of claim 6, wherein the antenna system has a bandwidth, under 1.2:1 VSWR, that is greater than 9.0 MHz.

8. The antenna system of claim 7, wherein the dipole arms inclined toward the panel at an angle of 45°±5°.

9. The antenna system of claim 8, wherein the dipole arms each have a length of approximately one quarter λ.

10. The antenna system of claim 9, wherein the antenna system has no feed straps.

11. A multi-layer system, comprising a number of layers comprising a number of bays, wherein each bay comprises an antenna system that is a broadband circularly-polarized combiner-capable FM broadcast antenna system, wherein each antenna system comprises:
a flat reflective panel;
four dipole arms mounted above the panel via a pillar comprising a single balun;
a parasitic ring mounted above the dipole arms; and
a multi-stage matching network,
wherein, in each antenna system:
the pillar is generally orthogonal to the panel;
the dipole arms are attached at one end to the pillar and radiate out from the pillar at angle of 90°±5° increments about pillar; and
the dipolar arms are connected to a single feed via the single balun and the matching network,
and wherein:
a first layer comprises three bays at a first orientation and pointing outward from a tower in different directions from a first level of the tower;
a second layer comprises three additional bays at a second orientation and pointing outward from the tower in different directions from a second level of the tower; and
the second level is below the first level; and
the second orientation is rotated 90°±5° from the first orientation.

12. The multi-layer system of claim 11, wherein, in each antenna system, the single balun comprises a balun tube having a diameter between four and seven inches.

13. The antenna system of claim 2, wherein, in each antenna system, the diameter of the single balun tube is approximately six inches.

14. The antenna system of claim 2, wherein, in each antenna system, each dipole arm has a diameter between 0.0100 and 0.0150 wavelengths (λ).

15. The antenna system of claim 4, wherein, in each antenna system, the diameter of each dipolar arm is approximately 0.0125λ.

16. The antenna system of claim 5 wherein, in each antenna system, with an applied feed power of 10 kW, exhibits a peak voltage of less than 5 kV/cm.

17. The antenna system of claim 6, wherein, in each antenna system, the antenna system has a bandwidth, under 1.2:1 VSWR, that is greater than 9.0 MHz.

18. The antenna system of claim 7, wherein, in each antenna system, the dipole arms inclined toward the panel at an angle of 45°±5°.

19. The antenna system of claim 8, wherein, in each antenna system, the dipole arms each have a length of approximately one quarter λ.

20. The antenna system of claim 9, wherein, in each antenna system, the antenna system has no feed straps.
